(19) United States
(12) Patent Application Publication
(10) Pub. No.: US 2014/0115234 A1
(43) Pub. Date: Apr. 24, 2014

(54) MEMORY SYSTEM COMPRISING NONVOLATILE MEMORY DEVICE AND RELATED METHOD OF OPERATION

(71) Applicant: SAMSUNG ELECTRONICS CO., LTD., Suwon-si (KR)

(72) Inventors: SEONGHOON WOO, HWASEONG-SI (KR); HAKSUN KIM, SUWON-SI (KR)

(73) Assignee: SAMSUNG ELECTRONICS CO., LTD., SUWON-SI (KR)

(21) Appl. No.: 13/659,235

(22) Filed: Oct. 24, 2012

(51) Int. Cl. G06F 12/02

(52) U.S. Cl. 711/103; 711/E12.008

(57) ABSTRACT

A method of programming a nonvolatile memory device comprises generating write data and metadata associated with the write data, generating a seed associated with the write data and scrambling the generated seed, randomizing the write data and the metadata using the scrambled seed, and programming the randomized write data, the randomized metadata, and the scrambled seed in the nonvolatile memory device.

### CROSS-REFERENCE TO RELATED APPLICATIONS

This application claims priority under 35 U.S.C. §119 to Korean Patent Application No. 10-2011-0120307 filed Nov. 17, 2011, the subject matter of which is hereby incorporated by reference.

### BACKGROUND OF THE INVENTION

The inventive concept relates generally to electronic memory technologies. More particularly, the inventive concept relates to a nonvolatile memory device, a memory system comprising the nonvolatile memory device, and related methods of operation.

Semiconductor memory devices can be roughly divided into two categories according to whether they retain stored data when disconnected from power. These categories include volatile memory devices, which lose stored data when disconnected from power, and nonvolatile memory devices, which retain stored data when disconnected from power. Examples of volatile memory devices include dynamic random access memory (DRAM), static random access memory (SRAM), and synchronous DRAM (SDRAM). Examples of nonvolatile memory devices include read only memory (ROM), programmable ROM (PROM), electrically programmable ROM (EPROM), electrically erasable and programmable ROM (EEPROM), a flash memory device, a phase-change RAM (PRAM), magnetic RAM (MRAM), resistive RAM (RRAM), and ferroelectric RAM (FRAM).

In an effort to improve greater storage capacity, researchers have developed nonvolatile memory devices capable of storing more than one bit of data per memory cell. Such devices are commonly referred to as multi-bit nonvolatile memory devices or multi-level cell (MLC) memory devices. Compared with single-bit nonvolatile memory devices, multi-bit nonvolatile memory devices currently suffer from relatively slow performance and reliability. Accordingly, there is a general need for techniques and technologies that can improve both performance and reliability in multi-bit nonvolatile memory devices.

### SUMMARY OF THE INVENTION

According to an embodiment of the inventive concept, a method of programming a nonvolatile memory device comprises generating write data and metadata associated with the write data, generating a seed associated with the write data and scrambling the generated seed, randomizing the write data and the metadata using the scrambled seed, and programming the randomized write data, the randomized metadata, and the scrambled seed in the nonvolatile memory device.

According to another embodiment of the inventive concept, a memory system comprises a nonvolatile memory device and a controller. The nonvolatile memory device comprises a single-level cell area and a multi-level cell area. The controller is configured to generate metadata associated with write data, generate a seed associated with the write data, scramble the generated seed, randomize the write data and the metadata using the scrambled seed, and program the randomized data, the randomized metadata, and the scrambled seed in the nonvolatile memory device.

These and other embodiments of the inventive concept can potentially improve the reliability of program operations in multi-bit nonvolatile memory devices.

### BRIEF DESCRIPTION OF THE DRAWINGS

The drawings illustrate selected embodiments of the inventive concept. In the drawings, like reference numbers indicate like features.

FIG. 1 is a block diagram illustrating a memory system comprising a nonvolatile memory device according to an embodiment of the inventive concept.

FIG. 2 is a flowchart illustrating a method of programming the nonvolatile memory device of FIG. 1 according to an embodiment of the inventive concept.

FIG. 3 is a flowchart illustrating a first step of a 3-step programming approach used to program memory cells in a multi-level cell area within the nonvolatile memory device of FIG. 1 according to an embodiment of the inventive concept.

FIG. 4 is a diagram illustrating threshold voltage distributions of memory cells in single-level cell and multi-level cell areas during the first-step programming operation of FIG. 3.

FIG. 5 is a diagram illustrating states of data programmed in a single-level cell area and a multi-level cell area using a 1-step programming approach according to an embodiment of the inventive concept.

FIG. 6 is a flowchart illustrating a second step of the 3-step programming approach used to program memory cells in the multi-level cell area according to an embodiment of the inventive concept.

FIG. 7 is a diagram illustrating threshold voltage distributions of memory cells in single-level cell and multi-level cell areas during a coarse programming operation according to an embodiment of the inventive concept.

FIG. 8 is a diagram illustrating states of data programmed in a single-level cell area and a multi-level cell area using the coarse programming operation according to an embodiment of the inventive concept.

FIG. 9 is a flowchart illustrating a third-step of the 3-step programming approach used to program memory cells in the multi-level cell area according to an embodiment of the inventive concept.

FIG. 10 is a diagram illustrating threshold voltage distributions of memory cells in single-level cell and multi-level cell areas during a fine programming operation according to an embodiment of the inventive concept.

FIG. 11 is a block diagram of a memory system according to an embodiment of the inventive concept.

FIG. 12 is a diagram illustrating a memory card according to an embodiment of the inventive concept.

FIG. 13 is a diagram illustrating a solid state drive according to an embodiment of the inventive concept.

FIG. 14 is a block diagram illustrating a computing system according to an embodiment of the inventive concept.

### DETAILED DESCRIPTION

Embodiments of the inventive concept are described below with reference to the accompanying drawings. These embodiments are presented as teaching examples and should not be construed to limit the scope of the inventive concept.

In the description that follows, the terms first, second, third, etc., may be used to describe various features, but these features are not to be limited by these terms. Rather, these terms are only used to distinguish between different features. Thus, a first feature could be alternatively referred to as a second feature, and vice versa, without changing the meaning of the relevant description.

The terminology used herein is for the purpose of describing particular embodiments only and is not intended to limit the inventive concept. As used herein, the singular forms “a”, “an” and “the” are intended to encompass the plural forms as well, unless the context clearly indicates otherwise. The terms “comprises” and/or “comprising,” when used in this specification, indicate the presence of stated features but do not preclude the presence or addition of other features. The term “and/or” indicates any and all combinations of one or more of the associated listed items.

Where a feature is referred to as being “on”, “connected to”, “coupled to”, or “adjacent to” another feature, it can be directly on, connected, coupled, or adjacent to the other feature, or intervening features may be present. In contrast, where a feature is referred to as being “directly on,” “directly connected to”, “directly coupled to”, or “immediately adjacent to” another feature, there are no intervening features present.

Unless otherwise defined, all terms (including technical and scientific terms) used herein have the same meaning as commonly understood by one of ordinary skill in the art. Terms such as those defined in commonly used dictionaries should be interpreted as having a meaning that is consistent with their meaning in the context of the relevant art and/or the specification and will not be interpreted in an idealized or overly formal sense unless expressly so defined herein.

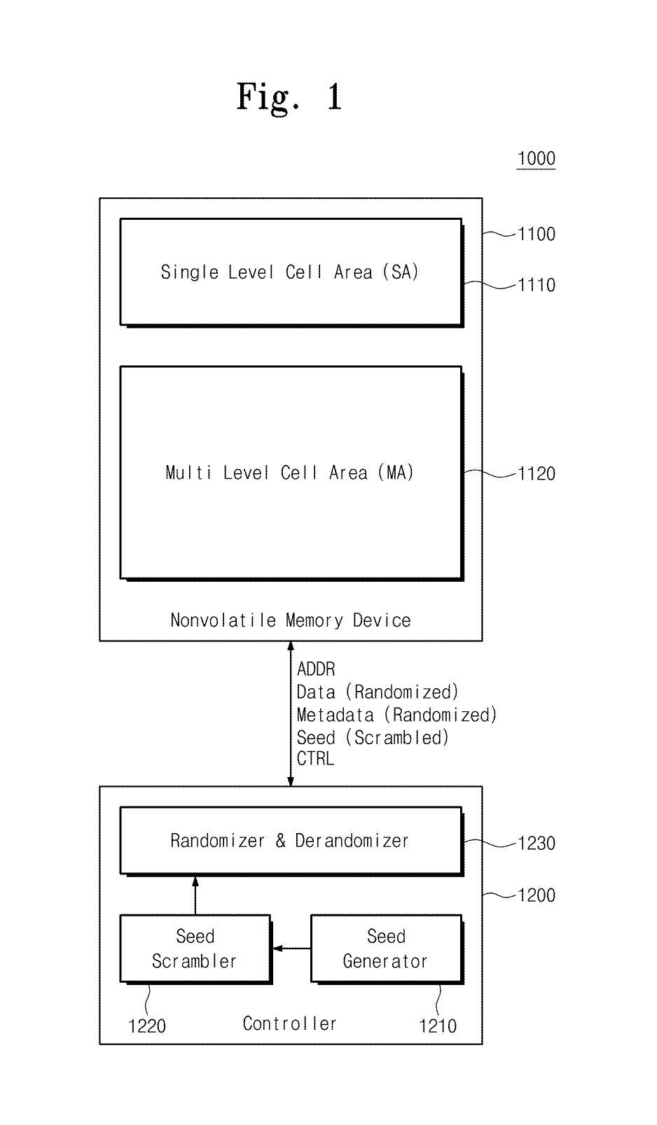

FIG. 1 is a block diagram illustrating a memory system 1000 comprising a nonvolatile memory device 1100 according to an embodiment of the inventive concept.

Referring to FIG. 1, memory system 1000 comprises nonvolatile memory device 1100 and a controller 1200. Nonvolatile memory device 1100 performs program, read, erase, and background operations under the control of controller 1200. Nonvolatile memory device 1100 may be, for example, a NAND flash memory.

Nonvolatile memory device 1100 comprises a single-level cell area 1110 and a multi-level cell area 1120. Single-level cell area 1110 comprises a plurality of memory cells each configured to store 1-bit data. Multi-level cell area 1120 comprises a plurality of memory cells each configured to store two or more bits of data. Single-level cell area 1110 and multi-level cell area 1120 are divided into memory blocks.

Controller 1200 controls program, read, erase, and background operations of nonvolatile memory device 1100. Controller 1200 typically communicates with nonvolatile memory device 1100 using information such as an address ADDR, data, metadata, a seed, and a control signal CTRL.

Address ADDR typically comprises an address associated with memory cells of nonvolatile memory device 1100 in which data is to be programmed, an address associated with memory cells of nonvolatile memory device 1100 from which data is to be read, or an address associated with memory cells of nonvolatile memory device 1100 to be erased.

The data comprises data to be programmed in nonvolatile memory device 1100 or data read out from nonvolatile memory device 1100. The data can include data randomized by controller 1200.

The metadata comprises metadata to be programmed in nonvolatile memory device 1100 or metadata read out from nonvolatile memory device 1100. The metadata typically comprises information required to control nonvolatile memory device 1100, such as information on data characteristics, information on statuses of nonvolatile memory device 1100, and information for error correction. The metadata can include metadata randomized by controller 1200.

The seed may be a pattern used by controller 1200 to randomize the data and the metadata. The seed may be a pattern scrambled by controller 1200.

Control signal CTRL comprises various signals that are generated by controller 1200 to control nonvolatile memory device 1100

Controller 1200 comprises a seed generator 1210, a seed scrambler 1220, and a randomizer and de-randomizer 1230.

Seed generator 1210 generates a seed. For example, seed generator 1210 may output a predetermined pattern of data as a seed. In some embodiments, seed generator 1210 stores a plurality of seeds using a table and selects a specific seed among the plurality of seeds based on input data. In some embodiments, seed generator 1210 selects the specific seed based on an address transferred from a host. In some embodiments, seed generator 1210 selects the specific seed based on a program and erase number of nonvolatile memory device 1100. In some embodiments, seed generator 1210 outputs a generated pattern as a seed without requiring input data.

Seed scrambler 1220 receives a seed from seed generator 1210 and scrambles the input seed. For example, seed scrambler 1220 may scramble the seed using an operation between adjacent bits, such as an AND operation or an exclusive-OR. Alternatively, seed scrambler 1220 may scramble the seed using an operation such as bit-swapping between adjacent bits. Randomizer and de-randomizer 1230 is configured to randomize or de-randomize data and metadata using a scrambled seed. Randomizer and de-randomizer 1230 may be configured to randomize data and metadata to be programmed in nonvolatile memory device 1100 in a program operation and to de-randomize data and metadata read out from nonvolatile memory device 1100 in a read operation.

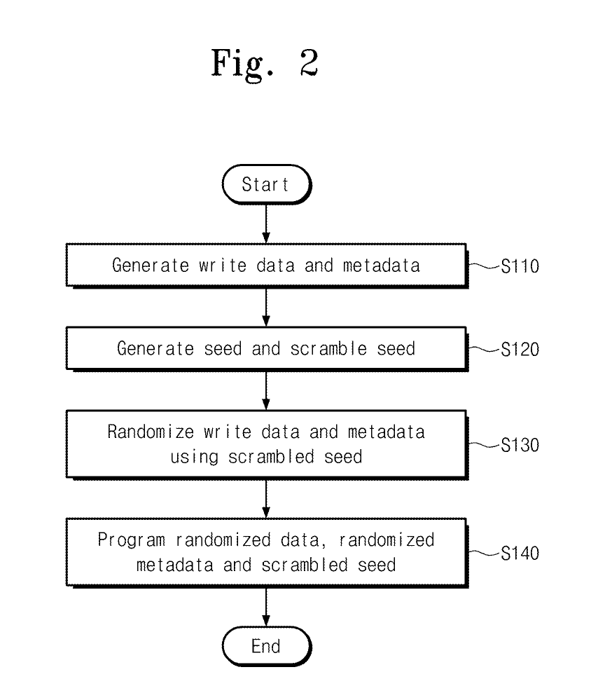

FIG. 2 is a flowchart illustrating a method of programming nonvolatile memory device 1100 according to an embodiment of the inventive concept. In the description that follows, example method steps are indicated by parentheses.

Referring to FIGS. 1 and 2, controller 1200 receives and/or generates write data and generates metadata (S110). For example, controller 1200 may receive write data from an external source such as a host. Controller 1200 typically receives an address with the write data. Controller 1200 can generate metadata based information such as the write data, the address, and/or a status of nonvolatile memory device 1100, for example.

Next, seed generator 1210 generates a seed, and seed scrambler 1220 scrambles the generated seed (S 120). Thereafter, randomizer and de-randomizer 1230 randomizes the write data and the metadata using the scrambled seed (S130).

Next, the randomized data, the randomized metadata, and the scrambled seed are programmed in nonvolatile memory device 1100 (S140). Controller 1200 typically sends the randomized data, the randomized metadata, and the scrambled seed to nonvolatile memory device 1100, and nonvolatile memory device 1100 programs the randomized data, the randomized metadata, and the scrambled seed in memory cells connected to a wordline in single-level cell area 1110 or multi-level cell area 1120.

Memory cells of multi-level cell area 1120 store LSB data, CSB data, and MSB data. Programming of the LSB, CSB, and MSB data is performed by a 3-step approach. Where programming is performed using the 3-step approach, memory cells of single-level cell area 1110 are used as a buffer memory.

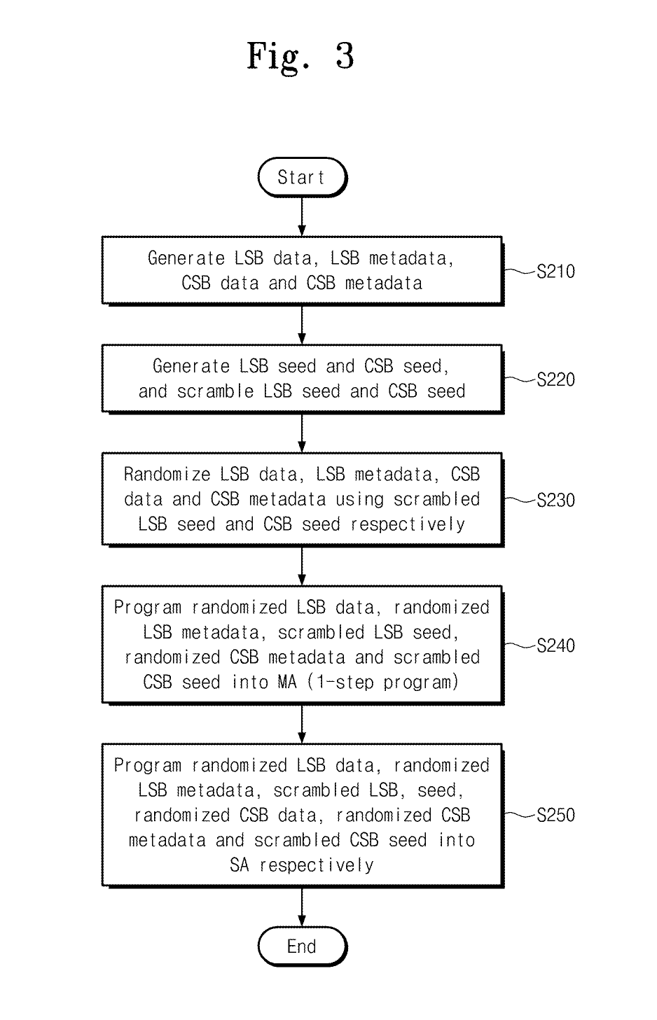

FIG. 3 is a flowchart illustrating a first step of the 3-step programming approach used to program memory cells in multi-level cell area 1120 according to an embodiment of the inventive concept.

Referring to FIGS. 1 and 3, LSB data, LSB metadata, CSB data, and CSB metadata are generated (S210). Controller 1200 typically receives the LSB and CSB data as write data from an external source such as a host. Controller 1200 generates the LSB metadata and the CSB metadata based on the LSB and CSB data.

Next, an LSB seed and a CSB seed are generated, and the LSB and CSB seeds are scrambled (S220). Seed generator 1210 typically generates the LSB seed corresponding to LSB data and the CSB seed corresponding to CSB data. Seed scrambler 1220 scrambles the LSB seed and the CSB seed.

Thereafter, the LSB data and LSB metadata are randomized using the scrambled LSB seed, and CSB data and CSB metadata are randomized using the scrambled CSB seed (S230). Randomizer and de-randomizer 1230 randomizes the LSB data and the LSB metadata using the LSB seed. Randomizer and de-randomizer 1230 also randomizes the CSB data and the CSB metadata using the CSB seed.

The randomized LSB data, the randomized LSB metadata, the scrambled LSB seed, the randomized CSB data, the randomized CSB metadata, and the scrambled CSB seed are programmed in a multi-level cell area 1120 (S240). The randomized LSB data, the randomized LSB metadata, the scrambled LSB seed, the randomized CSB data, the randomized CSB metadata, and the scrambled CSB seed are programmed in memory cells in a wordline of multi-level cell area 1120.

The randomized LSB data, the randomized LSB metadata, the scrambled LSB seed, the randomized CSB data, the randomized CSB metadata, and the scrambled CSB seed are then programmed in single-level cell area 1110 (S250). The randomized LSB data, the randomized LSB metadata, and the scrambled LSB seed are programmed in memory cells connected to a first wordline of single-level cell area 1110. The randomized CSB data, the randomized CSB metadata, and the scrambled CSB seed may be programmed in memory cells in a second wordline of single-level cell area 1110.

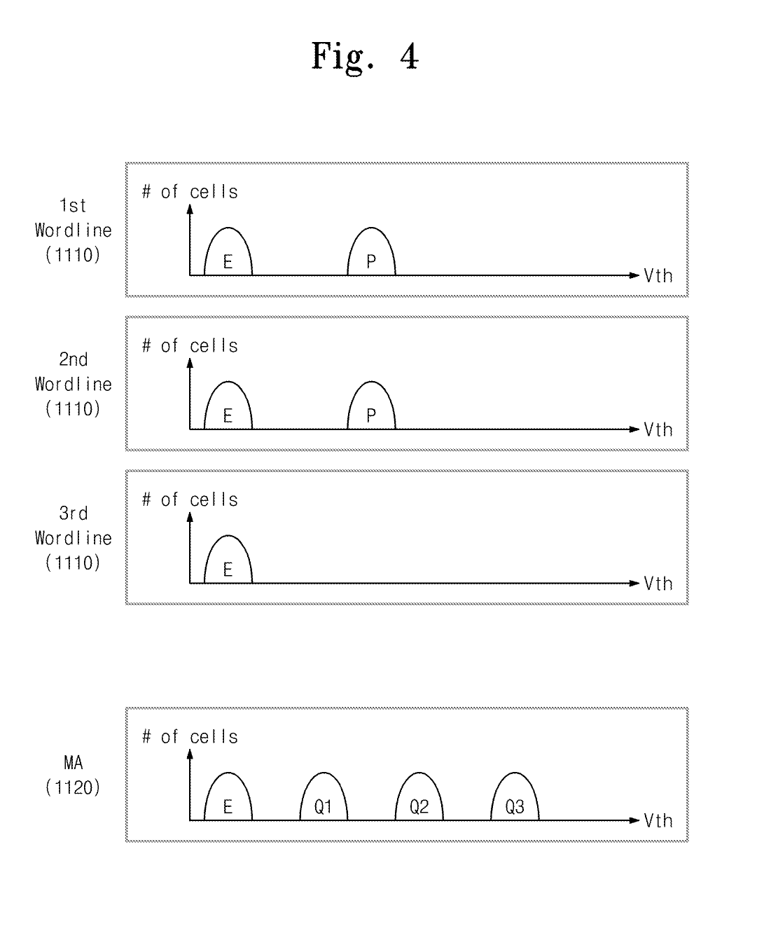

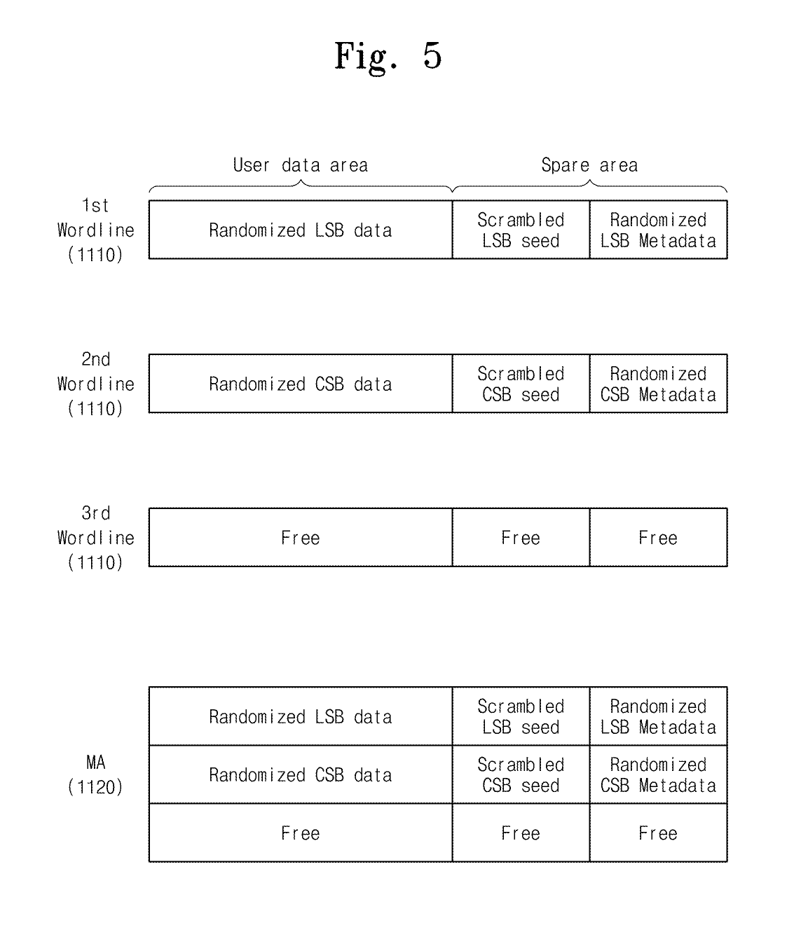

FIG. 4 is a diagram illustrating threshold voltage distributions of memory cells in single-level cell and multi-level cell areas during the first step of the 3-step programming approach of FIG. 3 according to an embodiment of the inventive concept. FIG. 5 is a diagram illustrating states of data programmed in a single-level cell area and a multi-level cell area using a 1-step programming approach according to an embodiment of the inventive concept. For explanation purposes, it will be assumed that programming is performed on memory cells connected to a wordline of multi-level cell area 1120 and memory cells connected to first through third wordlines of single-level cell area 1110.

Referring to FIGS. 4 and 5, 2-bit data is programmed in memory cells connected to the wordline of multi-level cell area 1120. The 2-bit data comprises randomized LSB data, randomized LSB metadata, randomized CSB data, and randomized CSB metadata. The memory cells may be programmed to any one of an erase state E and program states Q1 through Q3.

1-bit data is programmed in memory cells connected to the first wordline of single-level cell area 1110. This 1-bit data comprises randomized LSB data, randomized LSB metadata, and a scrambled LSB seed. The memory cells can be programmed to erased state E or a program state P, respectively. 1-bit data is also programmed in memory cells connected to the second wordline of single-level cell area 1110. This 1-bit data comprises randomized CSB data, randomized CSB metadata, and a scrambled CSB seed. Memory cells connected to the third wordline single-level cell area 1110 retain erase state E.

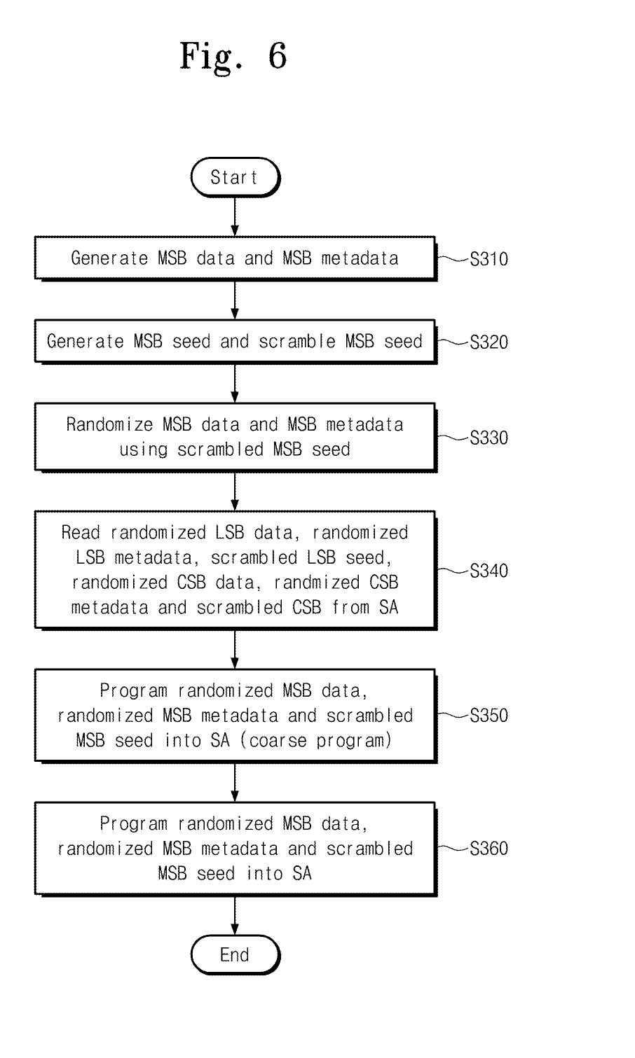

FIG. 6 is a flowchart illustrating a second step of the 3-step programming approach used to program memory cells in multi-level cell area 1120 according to an embodiment of the inventive concept.

Referring to FIGS. 1 and 6, MSB data and MSB metadata are generated (S310). For example, controller 1200 may receive the MSB data as write data from an external source such as a host. Controller 1200 typically generates the MSB metadata according to the MSB data.

Next, an MSB seed is generated, and the generated MSB seed is scrambled (S320). Seed generator 1210 typically generates the MSB seed, and seed scrambler 1220 scrambles the generated MSB seed.

Thereafter, the MSB data and the MSB metadata are randomized using the scrambled MSB seed (S330). Randomizer and de-randomizer 1230 typically randomizes the MSB data and the MSB metadata using the scrambled MSB seed.

Then, randomized LSB data, randomized LSB metadata, a scrambled LSB seed, randomized CSB data, randomized CSB metadata, and a scrambled CSB seed are read out from single-level cell area 1110 (S340).

Next, the randomized MSB data, the randomized MSB metadata, and the scrambled MSB seed are programmed in multi-level cell area 1120 (S350). This programming may be referred to as coarse programming.

Finally, the randomized MSB data, the randomized MSB metadata, and the scrambled MSB seed are programmed in memory cells connected to a third wordline of single-level cell area 1110 (S360).

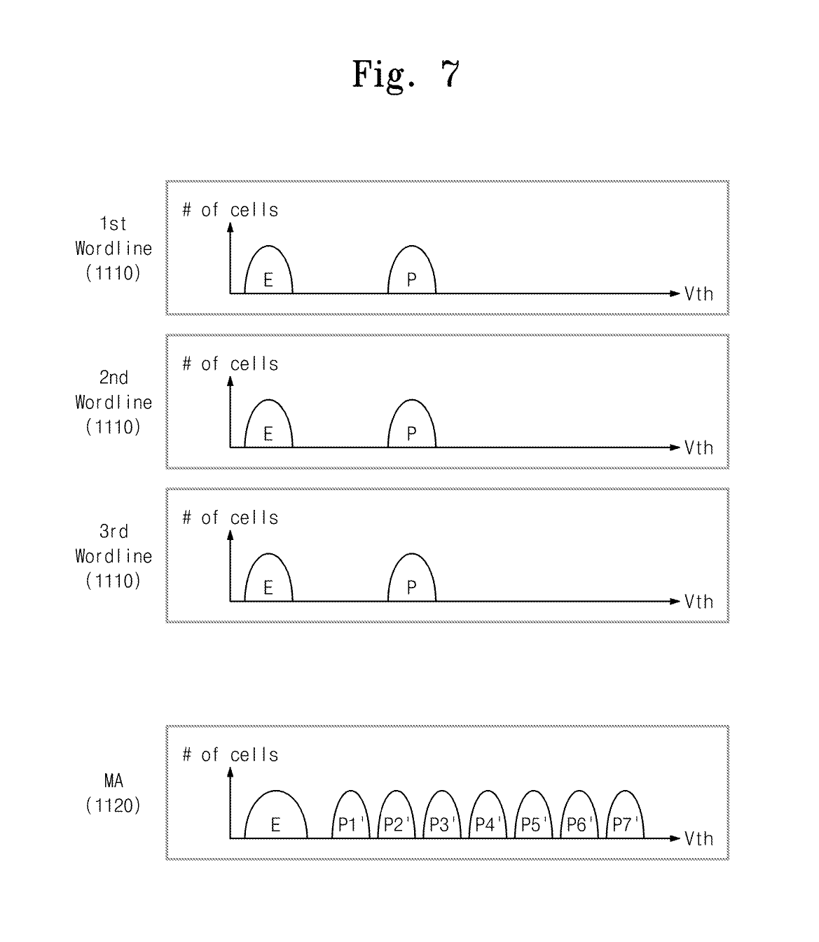

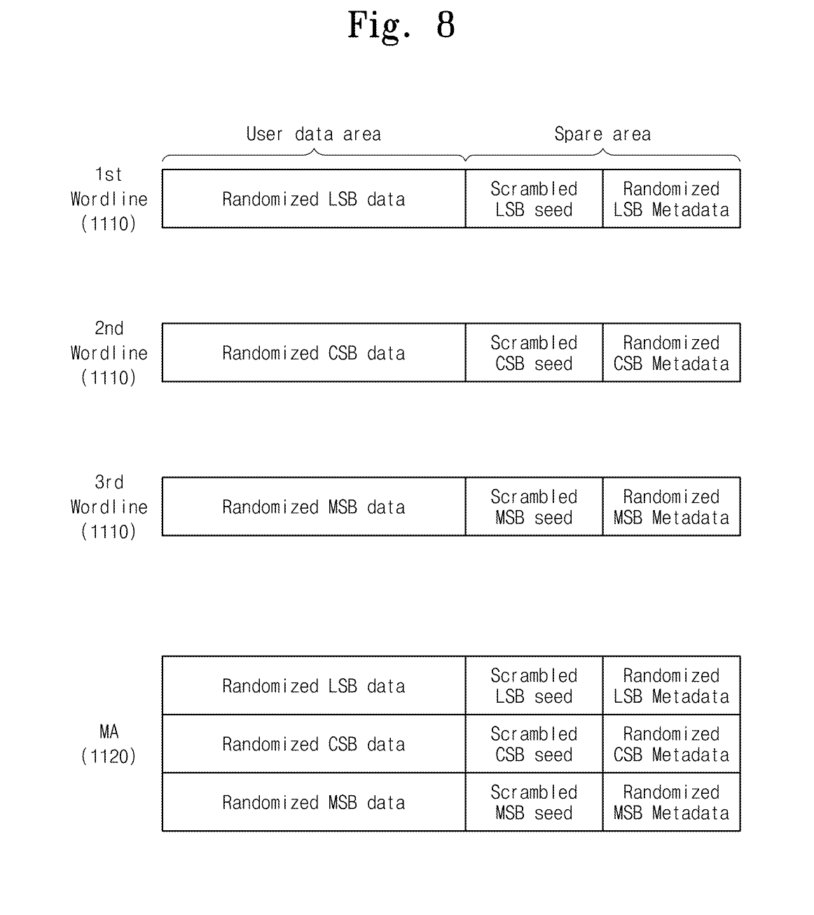

FIG. 7 is a diagram illustrating threshold voltage distributions of memory cells in single-level cell and multi-level cell areas during a coarse programming operation according to an embodiment of the inventive concept. FIG. 8 is a diagram illustrating states of data programmed in a single-level cell area and a multi-level cell area via coarse programming. For explanation purposes, it will be assumed that data is programmed in the memory cells connected to the wordline of multi-level cell area 1120 and memory cells connected to the first through third wordlines of single-level cell area 1110.

Referring to FIGS. 4 through 8, 1-bit data is further programmed in the memory cells connected to the wordline of multi-level cell area 1120. This 1-bit data comprises randomized MSB data, randomized MSB metadata, and a scrambled MSB seed. The memory cells then have any one of an erase state and program states P1′ through P7′. 1-bit data is then programmed in each of memory cells connected to a third wordline of a single-level cell area 1110. This 1-bit data comprises randomized MSB data, randomized MSB metadata, and a scrambled MSB seed. The memory cells then have erased state E or program state P.

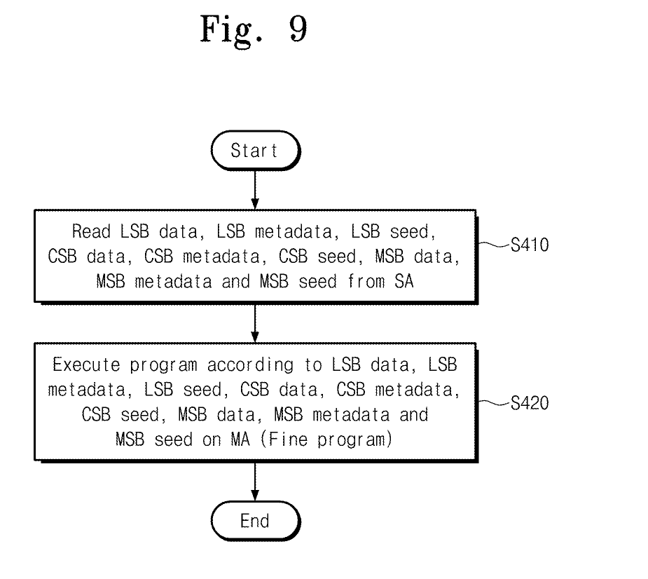

FIG. 9 is a flowchart illustrating a third step of the 3-step programming approach performed on multi-level cell area 1120 according to an embodiment of the inventive concept.

Referring to FIGS. 1 and 9, randomized LSB data, randomized LSB metadata, a scrambled LSB seed, randomized CSB data, randomized CSB metadata, a scrambled CSB seed, randomized MSB data, randomized MSB metadata, and a scrambled MSB seed are read out from single-level cell area 1110 (S410).

Next, programming is performed on multi-level cell area 1120 based on the randomized LSB data, randomized LSB metadata, scrambled LSB seed, randomized CSB data, randomized CSB metadata, scrambled CSB seed, randomized MSB data, randomized MSB metadata, and scrambled MSB seed (S420). This programming comprises fine programming.

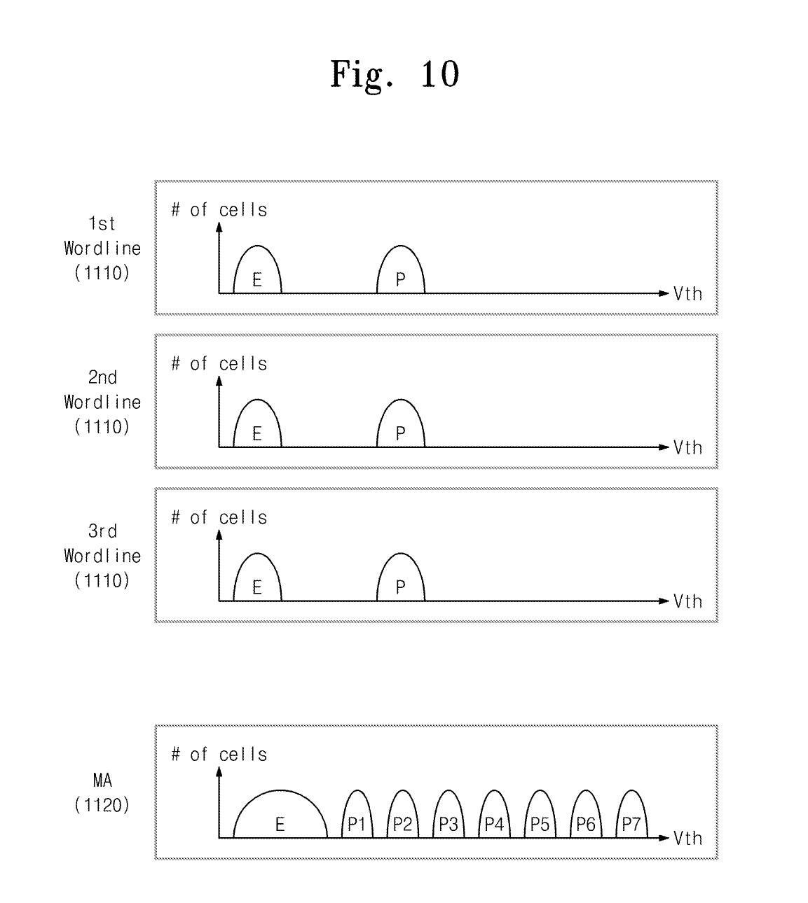

FIG. 10 is a diagram illustrating threshold voltage distributions of memory cells in single-level cell and multi-level cell areas during a fine programming operation according to an embodiment of the inventive concept. For explanation purposes, it will be assumed that programming is performed on memory cells connected to the wordline of multi-level cell area 1120 and the memory cells connected to first through third wordlines of single-level cell area 1110.

Compared with threshold voltage distributions in FIG. 7, memory cells of multi-level cell area 1120 are programmed to have a narrower threshold voltage distribution at a higher voltage level.

After programming (e.g., 1-step programming, coarse programming, or fine programming) is performed on the first wordline of multi-level cell area 1120, programming (e.g., 1-step programming, coarse programming, or fine programming) is performed on the second wordline, which is adjacent to the first wordline. After the programming is performed on the second wordline, memory cells of the first wordline may experience the coupling. Consequently, a threshold voltage distribution of memory cells connected to the first wordline may widen.

Where memory cells of the first and second wordlines are programmed using the 1-step approach, a threshold voltage distribution of memory cells connected to the first wordline may widen. Where coarse programming is carried out on memory cells connected to the first wordline, a threshold voltage distribution of the memory cells connected to the first wordline may become narrow (refer to FIG. 7). Because the coarse programming executed on the memory cells connected to the first wordline is performed according to data read out from single-level cell area 1110, the coarse programming executed on the memory cells connected to the first wordline may not be affected by coupling generated at 1-step programming performed on the second wordline.

Where the coarse programming is performed on memory cells connected to the second wordline, a threshold voltage distribution of the memory cells connected to the first wordline may widen. If the fine programming is executed on the memory cell connected to the first wordline, a threshold voltage distribution of the memory cells connected to the first wordline may become narrow (refer to FIG. 10). Since the fine programming executed on the memory cells connected to the first wordline is made according to data read out from single-level cell area 1110, the fine programming executed on the memory cells connected to the first wordline may not be affected by the coupling generated at course programming performed on the second wordline.

If the fine programming is performed on memory cells connected to the second wordline, a threshold voltage distribution of the memory cells connected to the first wordline may widen. However, referring to FIGS. 7 and 10, a variation in threshold voltages of memory cells at fine programming may be less than a variation in threshold voltages of memory cells in the 1-step programming approach and the coarse programming operation. That is, the coupling effect when the fine programming operation is performed on the memory cells connected to the second wordline may be less that that when the 1-step programming approach and the coarse programming operation are performed on the memory cells connected to the second wordline.

As described above, where the 3-step programming approach is used, it is possible to minimize coupling effect experienced by programmed memory cells in multi-level cell area 1120 (i.e., fine-programmed memory cells). Programming performed by the 3-step programming approach using single-level cell area 1110 as a buffer may be referred to as On-chip Buffered Programming (OBP).

Where data being programmed in nonvolatile memory device 1100 has a specific pattern, the reliability of the programmed data may decrease. For example, where data with the same pattern is programmed in a plurality of pages, an electric field among memory cells may be reinforced such that charges accumulated or trapped at memory cells are discharged. It is possible to prevent a specific pattern from being programmed in nonvolatile memory device 1100 by randomizing data (including write data, metadata, and a seed) and programming the randomized data. Thus, the reliability of data programmed in nonvolatile memory device 1100 may be improved.

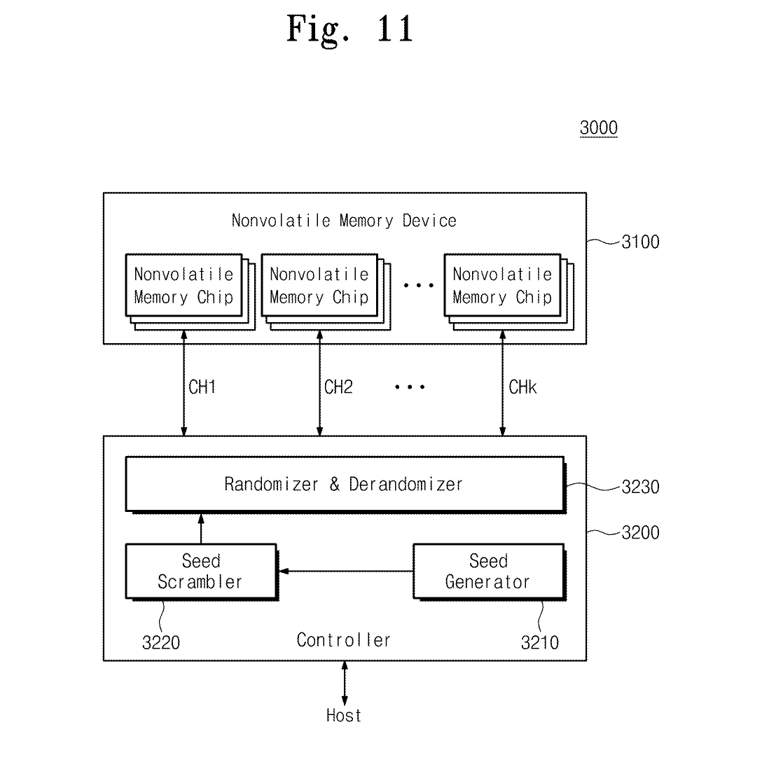

FIG. 11 is a block diagram of a memory system 3000 according to an embodiment of the inventive concept.

Referring to FIG. 11, memory system 3000 comprises a nonvolatile memory device 3100 and a controller 3200. Nonvolatile memory device 3100 comprises a plurality of nonvolatile memory chips, which form a plurality of groups. Nonvolatile memory chips in each group are configured to communicate with controller 3200 through a common channel. Alternatively, each channel could be associated with a single chip. In some embodiments, the plurality of nonvolatile memory chips communicate with controller 3200 via channels CH1 through CHk.

Controller 3200 comprises a seed generator 3210, a seed scrambler 3220, and a randomizer and de-randomizer 3230. As described in relation to FIGS. 1 through 9, controller 3200 scrambles a generated seed to randomize write data and metadata using the scrambled seed. The randomized data, the randomized metadata, and the scrambled seed are programmed in nonvolatile memory device 3100.

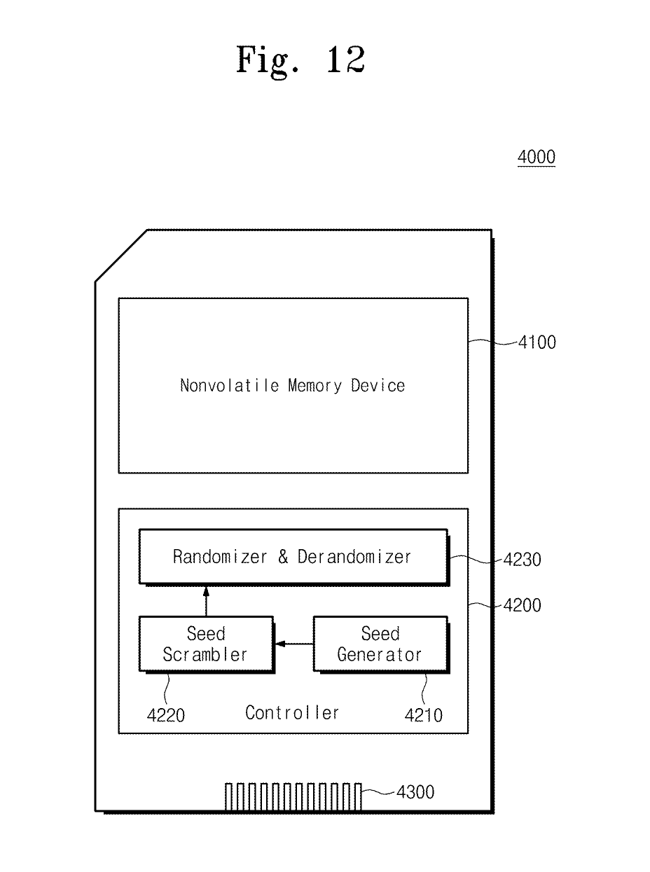

FIG. 12 is a diagram of a memory card 4000 according to an embodiment of the inventive concept.

Referring to FIG. 12, memory card 4000 comprises a nonvolatile memory device 4100, a controller 4200, and a connector 4300.

Nonvolatile memory device 4100 comprises a single-level cell area and a multi-level cell area.

Controller 4200 comprises a seed generator 4210, a seed scrambler 4220, and a randomizer and de-randomizer 4230. Similar to embodiments described in relation to FIGS. 1 through 9, controller 4200 may scramble a generated seed to randomize write data and metadata using the scrambled seed. The randomized data, the randomized metadata, and the scrambled seed may be programmed in nonvolatile memory device 4100. Connector 4300 connects memory card 4000 with a host electrically.

Memory card 4000 can take various alternative forms, such as a PC (PCMCIA) card, a CF card, an SM (or, SMC) card, a memory stick, a multimedia card (MMC, RS-MMC, MMCmicro), a security card (SD, miniSD, microSD, SDHC), or a universal flash storage (UFS) device, for example.

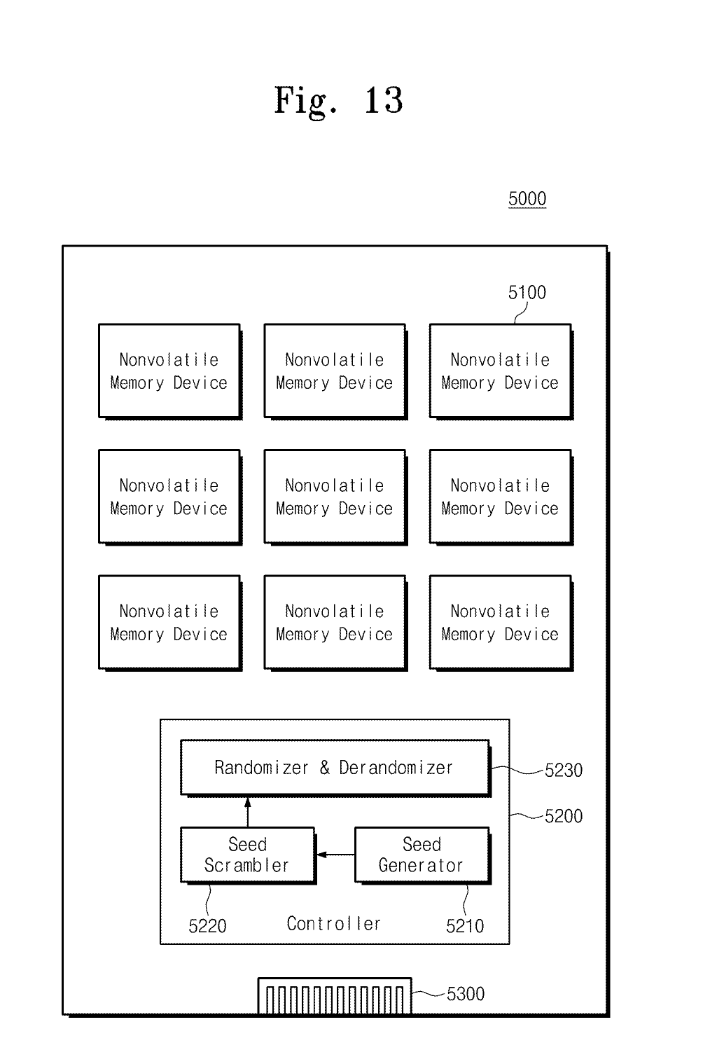

FIG. 13 is a diagram of a solid state drive 5000 according to an embodiment of the inventive concept.

Referring to FIG. 13, solid state drive 5000 comprises a plurality of nonvolatile memory devices 5100, a controller 5200, and a connector 5300.

Each of nonvolatile memory devices 5100 comprises a single-level cell area and a multi-level cell area. Some of nonvolatile memory devices 5100 may be single-level cell devices, and the others may be multi-level cell devices.

Controller 5200 comprises a seed generator 5210, a seed scrambler 5220, and a randomizer and de-randomizer 5230. Similar to embodiments described in relation to FIGS. 1 through 9, controller 5200 may scramble a generated seed to randomize write data and metadata using the scrambled seed. The randomized data, the randomized metadata, and the scrambled seed may be programmed in nonvolatile memory device 5100. Connector 5300 connects solid state drive 5000 with a host electrically.

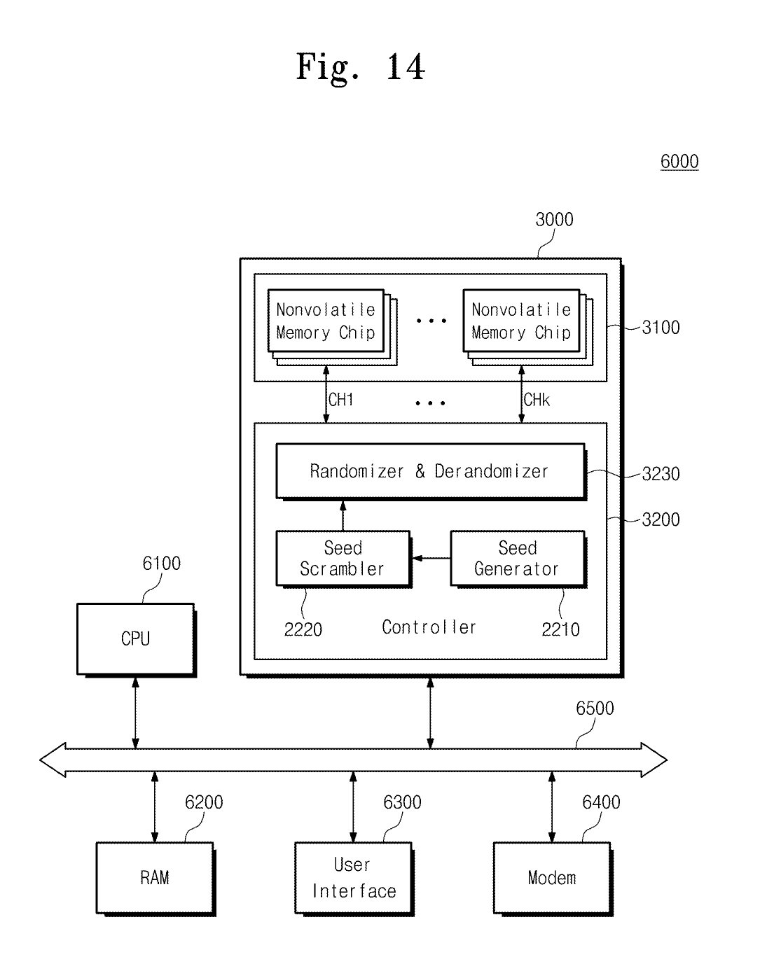

FIG. 14 is a block diagram of a computing system 6000 according to an embodiment of the inventive concept.

Referring to FIG. 14, computing system 6000 comprises a central processing unit 6100, a RAM 6200, a user interface 6300,

Memory system 3000 is connected electrically with elements 6100 through 6400 via a system bus 6500. Data provided via user interface 6300 or processed by central processing unit 6100 is stored in memory system 3000.

Although FIG. 14 shows nonvolatile memory device 3100 connected to system bus 6500 via controller 3200, nonvolatile memory device 3100 can alternatively be electrically connected directly to system bus 6500. Memory system 3000 of FIG. 14 can be a memory system such as that illustrated in FIG. 11 or FIG. 1.

As indicated by the foregoing, in certain embodiments of the inventive concept, user data, metadata, and a seed are randomized, and the randomized user data, metadata, and seed are programmed in a nonvolatile memory device. Thus, a programming method and a memory system with improved reliability may be provided.

The foregoing is illustrative of embodiments and is not to be construed as limiting thereof. Although a few embodiments have been described, those skilled in the art will readily appreciate that many modifications are possible in the embodiments without materially departing from the novel teachings and advantages of the inventive concept. Accordingly, all such modifications are intended to be included within the scope of the inventive concept as defined in the claims.

What is claimed is:

1. A method of programming a nonvolatile memory device, comprising:
generating write data and metadata associated with the write data;
generating a seed associated with the write data and scrambling the generated seed;
randomizing the write data and the metadata using the scrambled seed; and
programming the randomized write data, the randomized metadata, and the scrambled seed in the nonvolatile memory device.

2. The method of claim 1, wherein the randomized write data is programmed in memory cells of a user data area among memory cells connected to a wordline of the nonvolatile memory device, and the randomized metadata and the scrambled seed are programmed in memory cells of a spare area among the memory cells connected to the wordline.

3. The method of claim 1, wherein the nonvolatile memory device comprises a single-level cell area comprising memory cells each storing one bit and a multi-level cell area comprising memory cells each storing multiple bits.

4. The method of claim 3, wherein the write data comprises least significant bit (LSB) data and central significant bit (CSB) data, and generating the metadata comprises LSB metadata associated with the LSB data and CSB metadata associated with the CSB data.

5. The method of claim 4, wherein generating a seed associated with the write data and scrambling the generated seed comprises:
generating an LSB seed associated with the LSB data and scrambling the generated LSB seed; and
generating a CSB seed associated with the CSB data and scrambling the generated CSB seed.

6. The method of claim 5, wherein the write data comprises LSB data and CSB data, and randomizing the write data and the metadata using the scrambled seed comprises:
randomizing the LSB data and the LSB metadata using the scrambled LSB seed; and
randomizing the CSB data and the CSB metadata using the scrambled CSB seed.

7. The method of claim 6, wherein the write data comprises LSB data and CSB data, and programming the randomized write data, the randomized metadata, and the scrambled seed in the nonvolatile memory device comprises:
programming the randomized LSB data, the randomized LSB metadata, the scrambled LSB seed, the randomized CSB data, the randomized CSB metadata, and the scrambled CSB seed in memory cells connected to a wordline of the multi-level cell area;
programming the randomized LSB data, the randomized LSB metadata, and the scrambled LSB seed in memory cells connected to a first wordline of the single-level cell area; and
programming the randomized CSB data, the randomized CSB metadata, and the scrambled CSB seed in memory cells connected to a second wordline of the single-level cell area.

8. The method of claim 7, wherein the write data comprises MSB data, and generating write data and metadata comprises generating MSB metadata associated with the MSB data.

9. The method of claim 8, wherein the write data comprises MSB data, and generating a seed associated with the write data and scrambling the generated seed comprises:
generating a most significant bit (MSB) seed associated with the MSB data and scrambling the generated MSB seed.

10. The method of claim 9, wherein the write data comprises MSB data, and the randomizing the write data and the metadata using the scrambled seed comprises:
randomizing the MSB data and the MSB metadata using the scrambled MSB seed.

11. The method of claim 10, wherein the write data comprises MSB data, and the programming the randomized write data, the randomized metadata, and the scrambled seed in the nonvolatile memory device comprises:
reading the randomized LSB data, the randomized LSB metadata, and the scrambled LSB seed from memory cells connected to the first wordline;
reading the randomized CSB data, the randomized CSB metadata, and the scrambled CSB seed from memory cells connected to the second wordline;
programming the randomized MSB data, the randomized MSB metadata, and the scrambled MSB seed in memory cells connected to the wordline of the multi-level cell area, based on the randomized LSB data, the randomized LSB metadata, the scrambled LSB seed, the randomized CSB data, the randomized CSB metadata, and the scrambled CSB seed; and
programming the randomized MSB data, the randomized MSB metadata, and the scrambled MSB seed in memory cells connected to a third wordline of the single-level cell area.

12. The method of claim 11, further comprising:
reading the randomized LSB data, the randomized LSB metadata, and the scrambled LSB seed from memory cells connected to the first wordline;
reading the randomized CSB data, the randomized CSB metadata, and the scrambled CSB seed from memory cells connected to the second wordline;
reading the randomized MSB data, the randomized MSB metadata, and the scrambled MSB seed from memory cells connected to the third wordline; and
performing fine programming on memory cells connected to the wordline of the multi-level cell area, based on the randomized LSB data, the randomized LSB metadata, the scrambled LSB, the randomized CSB data, the randomized CSB metadata, the scrambled CSB seed, the randomized MSB data, the randomized MSB metadata, and the scrambled MSB seed.

13. A memory system, comprising:
a nonvolatile memory device comprising a single-level cell area and a multi-level cell area; and
a controller configured to generate metadata associated with write data, generate a seed associated with the write data, scramble the generated seed, randomize the write data and the metadata using the scrambled seed, and program the randomized data, the randomized metadata, and the scrambled seed in the nonvolatile memory device.

14. The memory system of claim 13, wherein the nonvolatile memory device and the controller constitute a memory card.

15. The memory system of claim 13, wherein the nonvolatile memory device and the controller constitute a solid state drive.

16. The memory system of claim 13, wherein the nonvolatile memory device is a NAND flash memory.

17. The memory system of claim 13, wherein the write data comprises least significant bit (LSB) data and central significant bit (CSB) data, and the metadata comprises LSB metadata associated with the LSB data and CSB metadata associated with the CSB data.

18. The memory system of claim 17, wherein the write data comprises LSB data and CSB data, and the controller generates and scrambles the seed associated with the write data by generating an LSB seed associated with the LSB data and scrambling the generated LSB seed, and generating a CSB seed associated with the CSB data and scrambling the generated CSB seed.

19. The memory system of claim 18, wherein the write data comprises LSB data and CSB data, and the controller randomizes the write data and the metadata using the scrambled seed by randomizing the LSB data and the LSB metadata using the scrambled LSB seed, and randomizing the CSB data and the CSB metadata using the scrambled CSB seed.

20. The memory system of claim 19, wherein the write data comprises LSB data and CSB data, and the controller programs the randomized write data, the randomized metadata, and the scrambled seed in the nonvolatile memory device by programming the randomized LSB data, the randomized LSB metadata, the scrambled LSB seed, the randomized CSB data, the randomized CSB metadata, and the scrambled CSB seed in memory cells connected to a wordline of the multi-level cell area, programming the randomized LSB data, the randomized LSB metadata, and the scrambled LSB seed in memory cells connected to a first wordline of the single-level cell area, and programming the randomized CSB data, the randomized CSB metadata, and the scrambled CSB seed in memory cells connected to a second wordline of the single-level cell area.
